(19) United States
(12) Patent Application Publication
(10) Pub. No.: US 2020/0338704 A1
(43) Pub. Date: Oct. 29, 2020

(54) CUP THAT SLIDES OVER A RACHET EXTENSION TO CATCH DRIPPING OIL DURING AN OIL FILTER CHANGE

(71) Applicant: Jeremey Earl Merrill, Lebanon, TN (US)

(72) Inventor: Jeremey Earl Merrill, Lebanon, TN (US)

(21) Appl. No.: 16/396,192

(22) Filed: Apr. 26, 2019

(51) Int. Cl. B25B 27/00

(52) U.S. Cl. CPC B25B 27/0042

(57) ABSTRACT

An oil change device having a bowl-like oil-change body defining a cavity for capturing run-off oil is provided. Extending upwardly from a central portion of the cavity is a tubular sleeve that a ratchet extension slides through. A seal element is provided along the tubular opening at the distal end of the sleeve, so that the ratchet extension and the sleeve form a liquid-tight seal. The ratchet extension operatively associates a ratchet with the oil filter wrench, which in turn loosens an oil filter. Thereby, excess oil drains down the ratchet extension, over the sleeve-extension interface and into the cavity when a user is changing an oil filter. Furthermore, the ratchet can be removed from the ratchet and the user can rotate the oil-change body to remove the oil filter.

### BACKGROUND OF THE INVENTION

The present invention relates to oil change systems and, more particularly, an oil-change device providing cup that slides over a ratchet extension to catch dripping oil during an oil filter change.

When changing a vehicle's oil filter, one of the challenges that may arise is that oil can drip off the bottom of the oil filter and get all over the undercarriage of the vehicle and the ground. The oil can also get all over the individual changing the oil, for example when trying to get the filter off the oil can run down their hands and arms, dripping off the elbow.

Current solutions rely on placing something on the ground, such as a catch basin, to capture the oil after it is released. In other words, when using a catch basin, the oil has to travel too far to get to the container thus affording the opportunity for the oil to run all over the place, including all over your undercarriage.

As can be seen, there is a need for an oil-change device providing cup that slides over a ratchet extension to catch dripping oil during an oil filter change, catching the oil at the source of the dripping. The present invention embodies a liquid tight design, containing the oil that comes off the bottom of the filter before it can accidentally go everywhere, making the whole process cleaner

### SUMMARY OF THE INVENTION

In one aspect of the present invention, an oil change device for changing oil filters includes the following: a bowl-like oil-change body defining a cavity; a tubular sleeve extends from a lower inner portion of the cavity for substantial portion of a depth of the cavity; and a seal element is provided along an inner opening at a distal end of the sleeve.

In another aspect of the present invention, an oil change device for changing oil filters includes a ratchet extension dimensioned to slide through said inner opening so as to form a liquid-tight seat between the ratchet extension and the seal element.

In yet another aspect of the present invention an oil-change system, further includes the above oil change device, wherein a ratchet operatively associated with one end of the ratchet extension; and an oil filter wrench operatively associated to an opposing end of the ratchet extension, wherein the ratchet extension extends above and below the sleeve. Thereby, a method of changing an oil filter includes the following: providing the above-mentioned oil change system; engaging the oil filter wrench to an oil filter coupled to an oil reservoir; torquing the ratchet sufficiently to loosen the oil filter from the oil reservoir; removing the ratchet so to eliminate some of a mass thereof; and letting said oil change system hang there while oil from the oil reserve falls along the ratchet extension into the cavity.

In yet another aspect of the present invention an oil-change system, an oil change device for changing oil filters includes the following: a bowl-like oil-change body defining a cavity, wherein said oil-change body has indented corners; an opening formed in a lower portion of the cavity; a seal element is provided along said opening, wherein the seal element is disposed in the cavity, wherein the seal element provides a compression fit; textured grips along an exterior surface of said indented corners; and a ratchet extension dimensioned to slide through said opening so as to form a liquid-tight seat between the ratchet extension and the seal element

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is an exploded perspective view of an exemplary embodiment of the present invention;

FIG. 3 is a section view of an exemplary embodiment of the present invention, taken along line 3-3 of FIG. 1;

FIG. 4 is a detailed section view of the exemplary embodiment of the present invention shown in FIG. 3;

FIG. 5 is a perspective view of an exemplary embodiment of the present invention;

FIG. 6 is a section view of an exemplary embodiment of the present invention, taken along line 6-6 of FIG. 5; and

FIG. 7 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

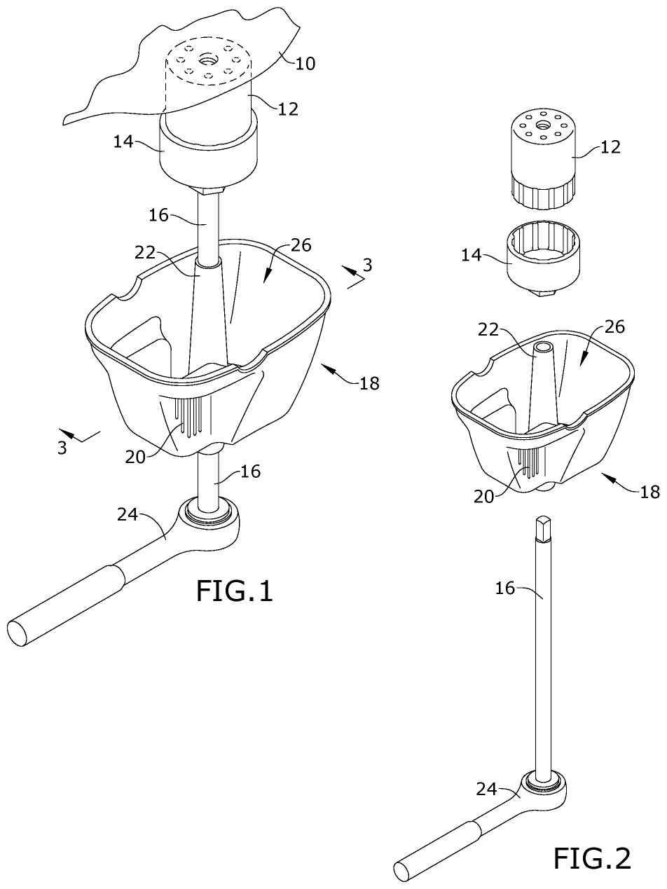

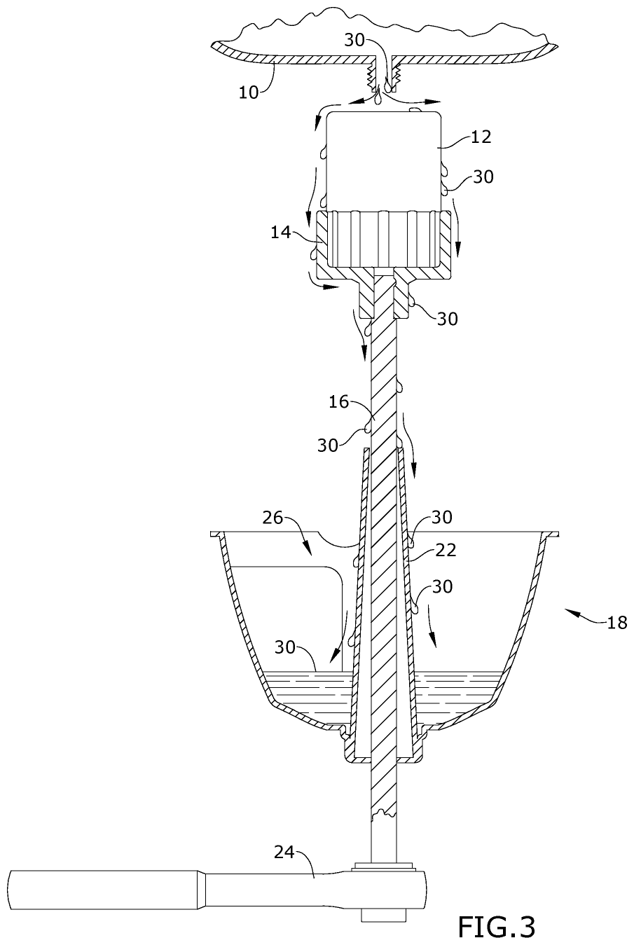

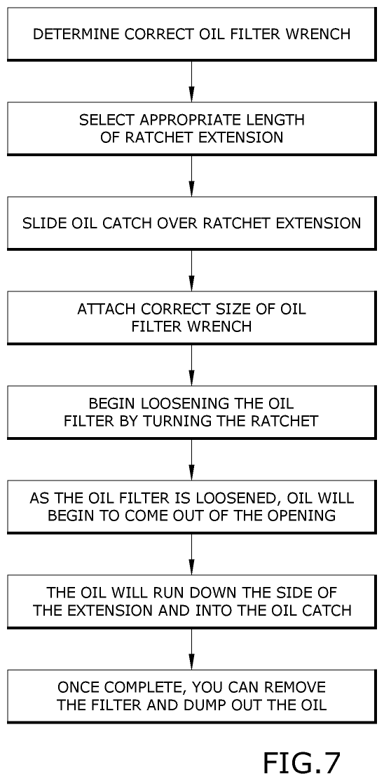

Broadly, the present invention may include an oil change device having a bowl-like oil-change body defining a cavity for capturing run-off oil. Extending upwardly from a central portion of the cavity is a tubular sleeve that a ratchet extension slides through. A seal element is provided along the tubular opening at the distal end of the sleeve, so that the ratchet extension and the sleeve form a liquid-tight seal. The ratchet extension operatively associates a ratchet with the oil filter wrench, which in turn loosens an oil filter. Thereby, excess oil drains down the ratchet extension, over the sleeve-extension interface and into the cavity when a user is changing an oil filter. Furthermore, the ratchet can be removed from the ratchet and the user can rotate the oil-change body to remove the oil filter. Referring now to FIGS. 1 through 7, the present invention may provide an oil-change device 50 providing an oil catch 18 coupled to a ratchet extension 16, wherein the ratchet extension 16 operatively associating a ratchet wrench 24 and an oil filter cup wrench 14. The ratchet extension 16 is dimensioned and adapted to provide sufficient clearance for the oil-change device 50. The ratchet extension 16 may be generally cylindrical as such a uniform curvature provides a surface that oil 30 and other fluids tend to migrate along.

The oil catch body 18 has a bowl-like shape that defines a cavity 26 for catching excess, run-off oil 30. The oil catch body 18 provides a centrally-disposed sleeve 22 extending upwardly from a lower portion of the cavity 26. The tubular sleeve 22 extends upward of, and so at a higher elevation relative to, an upper peripheral edge (“lip”) of the oil catch body 18. The oil catch body 18 may provide indented corners for facilitating manipulating it. Likewise, the oil catch body 18 may provide textured hand grips 20 along an exterior surface thereof for the same purpose.

It should be understood by those skilled in the art that the use of directional terms such as upper, lower, upward, downwardly, top and the like are used in relation to the illustrative embodiments as they are depicted in the figures, the upward direction (or upper) being toward the top of the corresponding figures and a downward direction being toward the bottom of the corresponding figures.

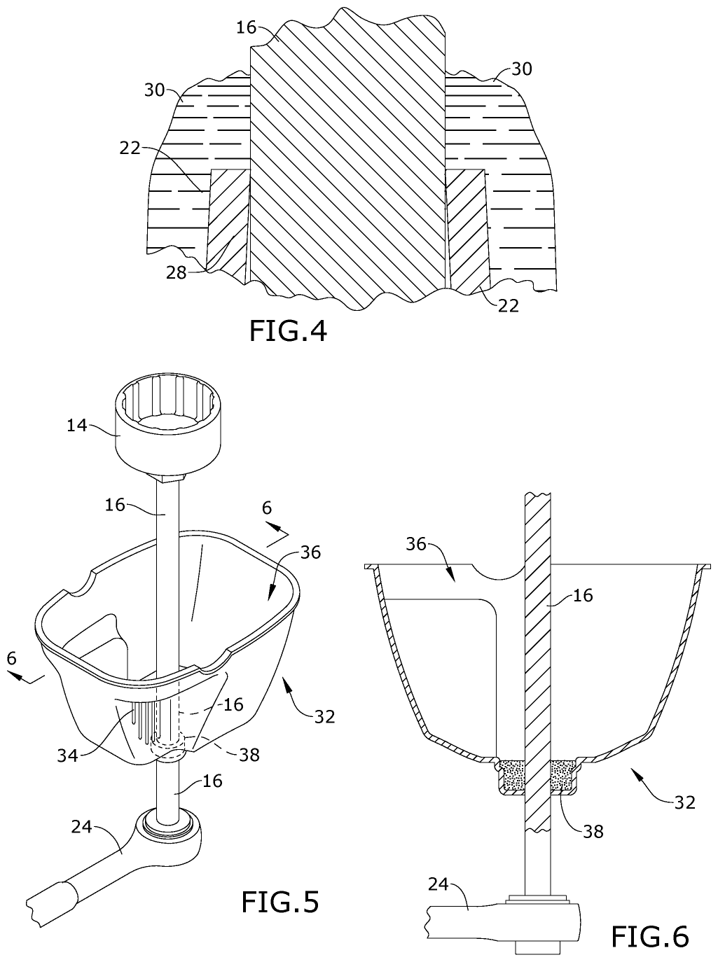

Along a distal end of the sleeve 22, within the tubular opening thereof, is a sealing device 28 dimensioned and adapted create a compression fit along the ratchet extension 16 for forming a liquid tight seal between the ratchet extension 16 and the opening of the sleeve 22 so that excess oil 30 must slide along the outside of the sleeve 22 (and into the cavity 26) as it cannot slide along the extension 16 between the interface of said distal end and the extension 16. In some embodiments, the sealing device 28 may be that the tubular opening diameter of the elongated sleeve 22 tapers inward until it snugly engages the ratchet extension 16, as illustrated in FIG. 4.

A method of using the present invention may include the following. The oil change device 50 disclosed above may be provided. A user may slide the oil change device 50 over the ratchet extensions 16, which slides through the opening of the sleeve 22, creating a liquid-tight seal between the ratchet extension 16 and the sleeve 22. When the oil 30 runs down the oil filter 12, from an oil reservoir 10, the oil 30 continues off the bottom of the filter 12 and down the ratchet extension 16 where it meets the interface of the extension 16-sleeve 22, and so flows thereover and gets captured in the cavity 26.

In other words, the present invention works in concert with an oil-filter cup wrench 14. Once a user has the correct filter wrench 14, the user determines the appropriate size required to work with the oil-change device 50. The length of the extension is what the user has to determine in order to work with their application. Common extensions that would work are 10″ and 12″. Several different sized extensions can be used together to create the optimal length needed to achieve the necessary clearance in order to use the ratchet extension 16 to make sure the user has enough clearance for the oil change device 50. Then the user simply slides the oil change device 50 down over the ratchet extension 16, with the cavity 26 facing up, and begins to loosen the oil filter 12. Being that oil filter cup wrench 14 fits tight on the bottom of the oil filter 12, the present invention will hold everything in place. The user can then disconnect the ratchet 24 from the extension 16 to eliminate some of the weight and let it hang there while it catches remainder of the dripping oil 30. Then using either the ratchet 24 or even one's hands, the filter 12 can be removed the rest of the way by rotating the oil changing device 50. After that, the user may remove the oil filter 12 from the filter cup wrench 14 and dump the oil 30 out of the cavity Here is where the textured grip would best come into play so as to have something to grab while dumping out the oil 30 in an appropriate place.

Referring to FIGS. 5 and 6, in another embodiment of the oil-change device 50, there is no tubular sleeve 22 that extends up through the center of an oil catch 32. The connection is made at the bottom of the oil catch 18 when you slide the ratchet extension 16 through a flat, thick “puck” or plug 38 wherein the liquid tight seal may again made through compression. The oil catch 32 would also define a cavity 36 for catching the excess oil 30, as well as have textured hand grips 34.

Additionally, the present invention can be used in any application where something that is caused to be removed mechanically produces fluid to be released.

It should be understood, of course, that the foregoing relates to exemplary embodiments of the invention and that modifications may be made without departing from the spirit and scope of the invention as set forth in the following claims.

What is claimed is:

1. An oil change device for changing oil filters, comprising:
a bowl-like oil-change body defining a cavity;
a tubular sleeve extends from a lower inner portion of the cavity for substantial portion of a depth of the cavity; and
a seal element is provided along an inner opening at a distal end of the sleeve.

2. The oil change device for changing oil filters of claim 1, further comprising textured grips along an exterior surface of said oil-change body.

3. The oil change device for changing oil filters of claim 1, wherein the seal element provides a compression fit through use of an inward tapering diameter of the tubular sleeve.

4. The oil change device for changing oil filters of claim 1, wherein said oil-change body has indented corners.

5. The oil change device for changing oil filters of claim 3, further comprising textured grips along an exterior surface of said indented corners.

6. The oil change device for changing oil filters of claim 1, further comprising a ratchet extension dimensioned to slide through said inner opening so as to form a liquid-tight seat between the ratchet extension and the seal element.

7. An oil-change system, comprising:
the oil change device of claim 6;
a ratchet operatively associated with one end of the ratchet extension; and
an oil filter wrench operatively associated to an opposing end of the ratchet extension,
wherein the ratchet extension extends above and below the sleeve.

8. A method of changing an oil filter, comprising:
providing the oil change system of claim 7;
engaging the oil filter wrench to an oil filter coupled to an oil reservoir;
torquing the ratchet sufficiently to loosen the oil filter from the oil reservoir;
removing the ratchet so to eliminate some of a mass thereof; and
letting said oil change system hang there while oil from the oil reserve falls along the ratchet extension into the cavity.

9. An oil change device for changing oil filters, comprising:
a bowl-like oil-change body defining a cavity, wherein said oil-change body has indented corners;
an opening formed in a lower portion of the cavity;
a seal element is provided along said opening, wherein the seal element is disposed in the cavity, wherein the seal element provides a compression fit;
textured grips along an exterior surface of said indented corners; and
a ratchet extension dimensioned to slide through said opening so as to form a liquid-tight seat between the ratchet extension and the seal element.
